(19) United States
(12) Patent Application Publication
(10) Pub. No.: US 2014/0374400 A1
(43) Pub. Date: Dec. 25, 2014

(54) WELDING TORCH

(71) Applicant: Solar Turbines Inc., San Diego, CA (US)

(72) Inventor: Julio C. Gerda, Humble, TX (US)

(21) Appl. No.: 13/921,838

(22) Filed: Jun. 19, 2013

(51) Int. Cl. B23K 9/12

(52) U.S. Cl. CPC B23K 9/122
USPC 219/137.31

(57) ABSTRACT

A welding torch is provided. The welding torch includes an insulating cup removably attached to a head portion of the welding torch. The insulating cup is configured to receive an electrode. The welding torch includes a grounding collar for a contact tip. The grounding collar is attached after the insulating cup and provided around the head portion of the welding torch. The grounding collar is configured to position the contact tip in angular relation to the electrode. The welding torch further includes a body extending from the grounding collar. The body is configured to have a substantially linear configuration.

### TECHNICAL FIELD

The present disclosure relates to a welding instrument, and more specifically to a welding torch used for different welding applications.

### BACKGROUND

Currently used welding torches for Gas Tungsten Arc Welding (GTAW) process are provided with a bent configuration specifically designed for pipe welding operations. These welding torch designs may provide accessibility issues in case of structural welding applications. Further, each time an electrode of the welding torch is replaced, a welding wire associated with the welding torch may need to be realigned.

Hence, there is a need for an improved welding torch design.

### SUMMARY OF THE DISCLOSURE

In one aspect of the present disclosure, a welding torch is provided. The welding torch includes an insulating cup removably attached to a head portion of the welding torch. The insulating cup is configured to receive an electrode. The welding torch includes a grounding collar for a contact tip. The grounding collar is attached after the insulating cup and provided around the head portion of the welding torch. The grounding collar is configured to position the contact tip in angular relation to the electrode. The welding torch further includes a body extending from the grounding collar. The body is configured to have a substantially liner configuration.

In another aspect, a welding torch is provided. The welding torch includes an insulating cup configured to house an electrode. The welding torch includes a grounding collar for a contact tip. The grounding collar is provided after the insulating cup and extends towards the electrode. The grounding collar is configured to position the contact tip in angular relation to the electrode. The insulating cup is further configured to be removed from the welding torch without affecting the position of the contact tip.

In yet another aspect, a welding torch is provided. The welding torch includes an insulating cup removably attached to a head portion of the welding torch. The insulating cup is configured to house an electrode. The welding torch includes a body having a substantially linear configuration. The welding torch further includes a grounding collar disposed between the head portion and the body. The grounding collar includes a clamping ring. The grounding collar includes a support arm having a first end and a second end. The first end of the support arm is removably attached to the clamping ring. The grounding collar further includes a contact tip fixedly attached to the second end of the support arm. The contact tip is configured to receive a welding wire and is angularly positioned relative to the electrode.

Other features and aspects of this disclosure will be apparent from the following description and the accompanying drawings.

### BRIEF DESCRIPTION OF THE DRAWINGS

FIG. 1 is a welding torch, according to one aspect of the present disclosure;

FIG. 2 is a grounding collar for the welding torch shown in FIG. 1; and

FIG. 3 is an exploded view of the welding torch shown in FIG. 1.

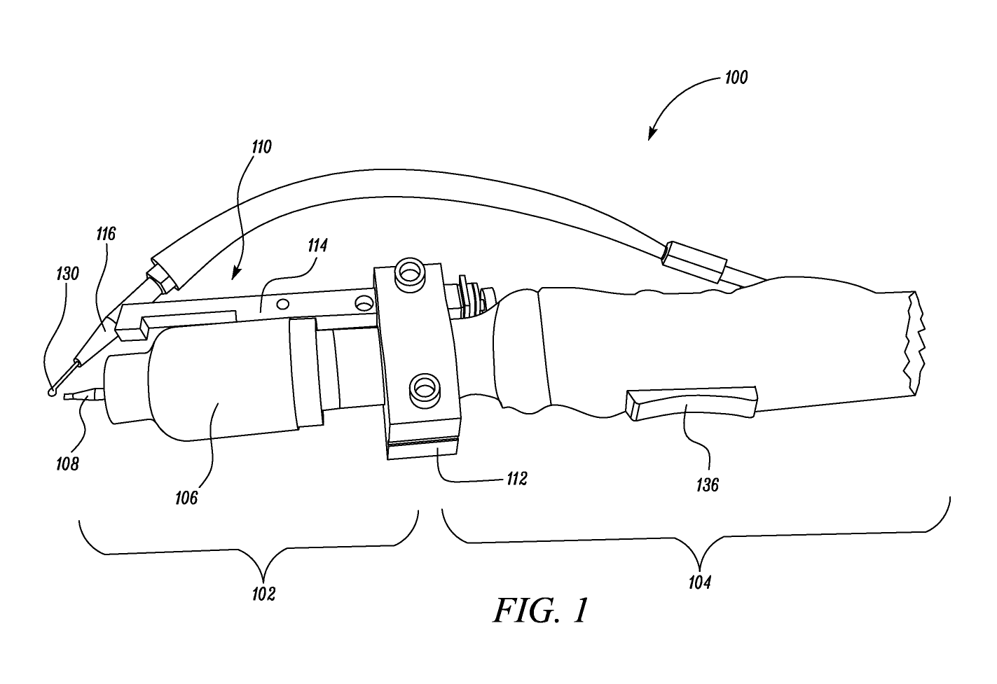

### DETAILED DESCRIPTION

Wherever possible, the same reference numbers will be used throughout the drawings to refer to the same or the like parts. Referring to FIG. 1, a welding torch 100 is shown. The welding torch 100 includes a head portion 102 and a body 104. The head portion 102 and the body 104 may be removably affixed to each other.

The head portion 102 includes an insulating cup 106. The insulating cup 106 may have a hollow cylindrical configuration. In the illustrated embodiment, the insulating cup 106 has a stepped configuration to provide a change in diameter of the insulating cup 106 as per design and/or operational needs. In another embodiment, the insulating cup 106 may have a hollow conical configuration.

The insulating cup 106 is removably attached to the head portion 102 of the welding torch 100. Accordingly, the insulating cup 106 may be provided with internal threads. The insulating cup 106 may be screw fitted by mating the internal threads with corresponding threads provided on the head portion 102 of the welding torch 100. Alternatively, the insulating cup 106 may be attached to the head portion 102 by any other known means. The insulating cup 106 may be made of ceramic. Any other metal, polymer or combination thereof having suitable thermal and electrical properties may also be used without any limitation.

In one embodiment, a gas lens (not shown) may be provided between the insulating cup 106 and the head portion 102. The gas lens may be provided with threads. The gas lens may be screw fitted to the insulating cup 106 and/or the head portion 102 of the welding torch 100 by mating the threads with corresponding threads provided on the insulating cup 106 and/or the head portion 102. Alternatively, the gas lens may be coupled to the insulating cup 106 and/or the head portion 102 by any other known means. The gas lens may be configured to provide a supply of shielding gas required for a welding operation.

The insulating cup 106 is configured to receive an electrode 108 at an end distal from the engagement of the insulating cup 106 with the body 104 of the welding torch 100. In the illustrated embodiment, the electrode 108 is a tungsten electrode configured for Gas Tungsten Arc Welding (GTAW) process. It should be noted that the electrode 108 may be any other metal electrode as per design and operational requirements.

Further, the welding torch 100 includes a grounding collar 110. The grounding collar 110 is positioned after the insulating cup 106 distal from the electrode, between the head portion 102 and the body 104 of the welding torch 100. Further, the grounding collar 110 may be provided around the head portion 102 of the welding torch 100 in a manner extending towards the electrode 108. The grounding collar 110 includes a clamping ring 112, a support arm 114 and a contact tip 116. The grounding collar 110 may be configured to position the contact tip 116 in an angular relation to the electrode 108.

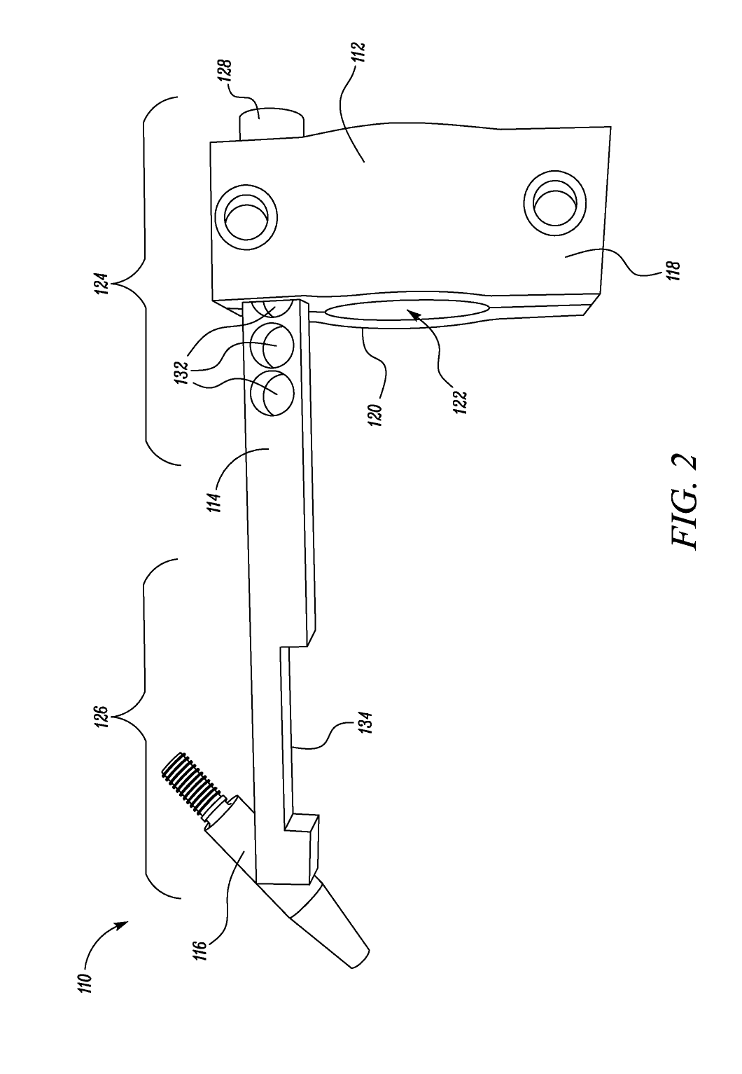

FIG. 2 illustrates a perspective view of the grounding collar 110. The clamping ring 112 may have a first section 118 and a second section 120. The first and second sections 118, 120 may be symmetrical to each other. The first and second sections 118, 120 may have a substantially curved configuration. On appropriately conjugating the first and second sections 118, 120 above each other, a hollow portion 122 may be formed between the first and second sections 118, 120. The body 104 of the welding torch 100 may be received within the hollow portion 122. The first and second sections 118, 120 may be removably affixed to each other and surrounding the body 104 of the welding torch 100. One or more mechanical fasteners including, but not limited to, bolts, screws and rivets may be used for the attachment. The clamping ring 112 may be made of fiberglass. Alternatively, any other electrical insulating material having suitable electrical and thermal properties may be used.

The clamping ring 112 may be provided with the support arm 114 on one side. The support arm 114 may have a first end 124 and a second end 126. The support arm 114 may be removably affixed to the clamping ring 112 at the first end 124 using any known means. A connection tab 128 may be provided on the first end of the support arm. The connection tab 128 may be configured to attach an electric wire or cable for providing an electrical supply to the welding torch 100.

The contact tip 116 may be provided on the second end 126 of the support arm 114. The contact tip 116 may have a hollow cylindrical configuration with a conical end. The contact tip 116 may be affixed to the second end 126 of the support arm 114 by any known mechanical fastening method like welding, brazing, bolting and so on. The contact tip 116 may be configured to receive a welding wire 130. The welding wire 130 may be made of any suitable metal, such as, for example, brass.

The attachment of the contact tip 116 with the support arm 114 may be such that the contact tip 116 is configured to be positioned in angular orientation with respect to the electrode 108. More specifically, the contact tip 116 may be angularly oriented such that the angle between the contact tip 116 or the welding wire 130 and the electrode 108 may be in a range between 40° and 50°. In one embodiment, this angle may be approximately 42.5°. It should be noted that the angle may vary. Also, alignment of the contact tip 116 and the electrode 108 may need to be maintained as per welding requirements in order to achieve a desired weld configuration.

Further, the support arm 114 may be provided with a plurality of holes 132 in a spaced apart arrangement, proximate to the first end 124 of the support arm 114. Based on engagement of any one of the plurality of holes 132 with the clamping ring 112, a length of the support arm 114 may be adjusted. The adjustment in the length of the support arm 114 may facilitate appropriate alignment of the contact tip 116 with respect to the electrode 108, based on varying sizes of the insulating cup 106. A longitudinal notch 134 may be provided on the second end 126 of the support arm 114 such that the longitudinal notch 134 may be adjacent to the insulating cup 106. The longitudinal notch 134 may be configured to prevent the support arm 114 from interfering with a tool and allowing ease of access to the insulating cup 106 during assembly and/or disassembly of the insulating cup 106.

The support arm 114 may be made of any suitable metal. In the given embodiment, the support arm 114 is made of brass. A person of ordinary skill in the art will appreciate that a lower coefficient of expansion of brass may prevent the support arm 114 from expanding considerably compared to other metals like steel which have a relatively higher coefficient of expansion. Hence, the support arm 114 may be prevented from loosening from the clamping ring 112 when heated during a welding operation. In addition, loss of alignment between the contact tip 116 and the electrode 108 may be prevented due to lower expansion of brass.

As shown in the accompanying figures, the body 104 of the welding torch 100 may have a substantially linear configuration. The body 104 may have a cylindrical or rod like configuration, though any other configuration may be also be used without any limitation. The body 104 may be provided with an electrical switch 136 for regulating the electrical supply to the welding torch 100. The body 104 may be made of any suitable metal, polymer or combination thereof as per system design.

### INDUSTRIAL APPLICABILITY

Known welding torch designs used for GTAW process are specifically configured for pipe welding operations. These welding torches have a bent configuration such that a head of the welding torch is angled at approximately 70° with respect to a body of the welding torch. Further, an insulating cup and a collar of the welding torch are integrally connected with each other. In this design, each time the insulating cup is detached from the body of the welding torch, the collar may need to be re-aligned with respect to an electrode affixed to the insulating cup, due to the integrated arrangement of the insulating cup and the collar. Additionally, the collar used in the current welding torch design is made of metal which may cause arcing when the collar is brought in contact with the body of the welding torch. Arcing may lead to formation of pores on the body of the welding torch, resulting in leakage of coolant from within the body.

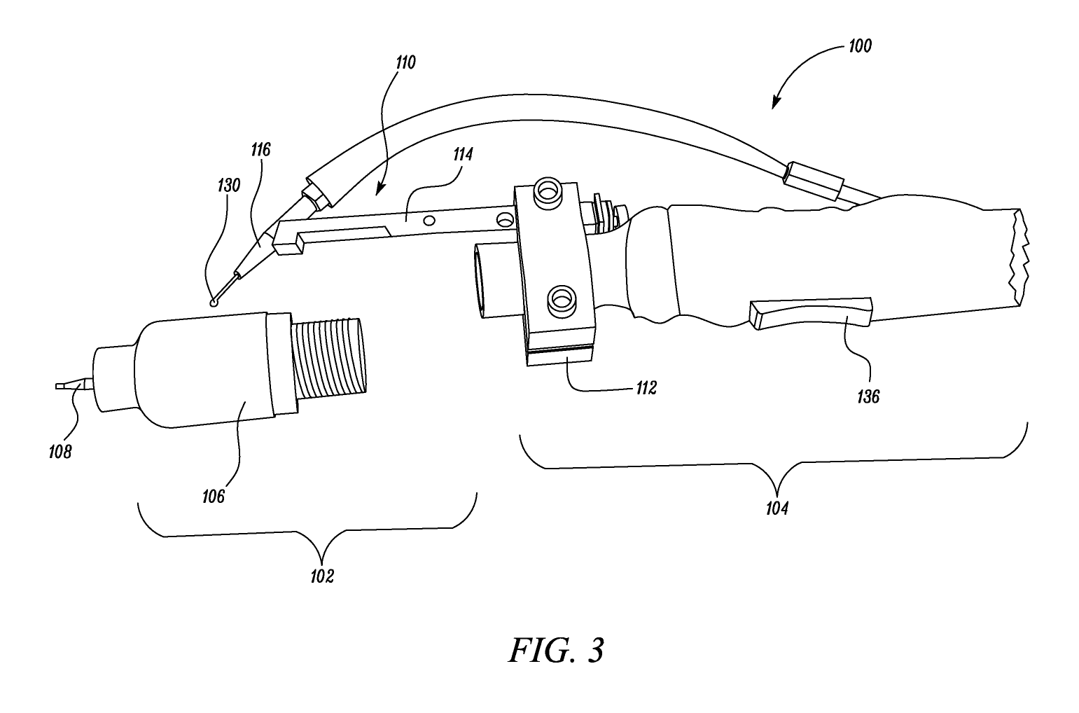

The present disclosure provides the welding torch 100 configured for structural applications or pipe welding applications. More specifically, the linear configuration of the welding torch 100 may provide improved access to confined areas for structural applications. Referring to FIG. 3, an exploded view of the welding torch 100 is illustrated. The electrode 108 is provided in the insulating cup 106. As described earlier, the insulating cup 106 may be removably affixed to the head portion 102 of the welding torch 100, and the grounding collar 110 may be removably affixed between the head portion 102 and the body 104 of the welding torch 100.

The electrode 108 may need to be removed and cleaned during operation of the welding torch 100. FIG. 3 depicts that the insulating cup 106 may be removed or affixed to the head portion 102 of the welding torch 100 without disturbing the arrangement of the grounding collar 106. Further, the alignment between the contact tip 116 associated with the grounding collar 110 and the electrode 108 may not be affected when the insulating cup 106 is detached from the head portion 102 of the welding torch 100 for various purposes such as, for example, replacement, grinding, or cleaning of the electrode 108. Hence, the design of the welding torch 100 provided herein may provide improved access to the insulating cup 106 and the electrode 108 during the assembly and/or disassembly process.

The clamping ring 112 disclosed herein is made of an electrically insulating material, such as, for example, fiberglass. This may prevent arcing between the clamping ring 112 and the body 104 of the welding torch 100. Further, the clamping ring 112 may maintain the support arm 114 away from the body 104 of the welding torch 100 and may accordingly prevent arcing between the support arm 114 and the body 104 as well. Additionally, this arrangement may prevent arcing between the clamping ring 112 and a working metal when the clamping ring 112 is brought in contact with the working metal during the welding operation.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A welding torch comprising:
an insulating cup removably attached to a head portion of the welding torch, the insulating cup configured to receive an electrode;
a grounding collar for a contact tip, the grounding collar attached after the insulating cup and provided around the head portion of the welding torch, wherein the grounding collar is configured to position the contact tip in angular relation to the electrode; and
a body of the welding torch extended from the grounding collar, the body having a substantially liner configuration.

2. The welding torch of claim 1, wherein the grounding collar further comprises:
a clamping ring configured to attach the grounding collar to the welding torch; and
a support arm configured to angularly position the contact tip relative to the electrode.

3. The welding torch of claim 2, wherein the clamping ring is made of fiberglass.

4. The welding torch of claim 2, wherein the support arm is made of brass.

5. The welding torch of claim 2, wherein a length of the support arm is adjustable based on a size of the insulating cup.

6. The welding torch of claim 1, wherein the angle formed between the contact tip and the electrode lies in a range between 40° and 50°.

7. The welding torch of claim 1, wherein the grounding collar is configured to receive an electrical supply.

8. The welding torch of claim 1, wherein the grounding collar is attached distal from the contact tip.

9. A welding torch comprising:
an insulating cup configured to house an electrode; and
a grounding collar for a contact tip, the grounding collar provided after the insulating cup and extending towards the electrode, the grounding collar configured to position the contact tip in angular relation to the electrode;
wherein the insulating cup is configured to be removed from the welding torch without affecting the position of the contact tip.

10. The welding torch of claim 9, wherein the welding torch has a substantially linear configuration.

11. The welding torch of claim 9, wherein the grounding collar further comprises:
a clamping ring configured to attach the grounding collar to the welding torch; and
a support arm configured to angularly position the contact tip relative to the electrode.

12. The welding torch of claim 11, wherein the clamping ring is made of fiberglass.

13. The welding torch of claim 11, wherein the support arm is made of brass.

14. The welding torch of claim 11, wherein a length of the support arm is adjustable based on a size of the insulating cup.

15. The welding torch of claim 9, wherein the angle formed between the contact tip and the electrode lies in a range between 40° and 50°.

16. The welding torch of claim 9, wherein the grounding collar is attached distal from the contact tip.

17. A welding torch comprising:
an insulating cup removably attached to a head portion of the welding torch, the insulating cup configured to house an electrode;
a body having a substantially linear configuration; and
a grounding collar disposed between the head portion and the body, the grounding collar comprising:
a clamping ring;
a support arm having a first end and a second end, the first end of the support arm removably attached to the clamping ring; and
a contact tip fixedly attached to the second end of the support arm, the contact tip configured to receive a welding wire, wherein the contact tip is angularly positioned relative to the electrode.

18. The welding torch of claim 17, wherein the clamping ring is made of fiberglass.

19. The welding torch of claim 17, wherein the support arm is made of brass.

20. The welding torch of claim 17, wherein a length of the support arm is adjustable based on a size of the insulating cup.
